(19) United States
(12) Patent Application Publication
(10) Pub. No.: US 2005/0157791 A1
(43) Pub. Date: Jul. 21, 2005

(54) System and method for video tone scale reduction

(75) Inventor: Zhaohui Sun, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/761,058

(22) Filed: Jan. 20, 2004

(51) Int. Cl. H04N 7/12

(52) U.S. Cl. 375/240.16; 348/27; 375/240.03

(57) ABSTRACT

In a method, apparatus, and system, tone scale of a video is reduced. A cumulative diffused error is added to an initial tone value of a base pixel of a current frame of the video to provide an adjusted tone value of the pixel. A threshold is assigned to said base pixel. The adjusted tone value is quantized using the threshold and a quantization error is generated. First portions of the quantization error are diffused to pixels of temporally neighboring frames and second portions are diffused to spatially neighboring pixels of the current frame. The portions at a next pixel are totalled to provide a respective cumulative diffused error and the assigning, quantizing, and diffusing steps are iterated until all of the pixels of the video frames are processed.

### FIELD OF THE INVENTION

The invention relates to the field of digital video and image sequence processing, including halftoning, and in particular to the video tone scale reduction methods and systems.

### BACKGROUND OF THE INVENTION

There is an increasing demand for video processing techniques, which include a reduction in tone scale to accommodate the limitations of a particular device or system, with minimal visual degradation. The term “tone scale”, as used herein, refers to a scale of uniform steps of luminance or density in a subject or image. (The steps are referred to herein as “tone values”.) A tone scale can be black-and-white halftone, limited to two steps. A tone scale can alternatively be multitoned, that is having more than two steps, but less than an original or “full” resolution. A tone scale can be provided for a hue, rather than black. The term “colortone” is used herein to refer to a multiple hue image or scale, in which each available hue or primary color is provided as a halftone or multitone scale. Video tone scale reduction includes generation of halftone video (with only black and white intensity levels), multitone video (with more than 2 intensity levels), and colortone video (with multiple color channels).

Image halftoning reduces the intensity/color resolution of an image for the best possible reproduction, and has wide applications in printing and display industries. A number of techniques have been proposed, such as the error diffusion, ordered dither, dot diffusion, and stochastic screening. Selected algorithms are available in “An adaptive algorithm for spatial grey scale”, R. Floyd and L. Steinberg, Proc. Society for Information Display 17, 2, 75-77, (1976), and “A simple and efficient error-diffusion algorithm” by V. Ostromoukhov, Proceedings of ACM SIGGRAPH 2001, 567-572, (2001).

Still image halftoning techniques are widely used to convert a continuous tone image to a halftone image or other reduced tone image in the printing and display industries. These techniques for still images are not directly suitable for use with digital video, due to the additional temporal dimension.

Modifications of still image halftoning techniques to video have tended to suffer from introduced temporal flickering artifacts and degradation of spatiotemporal video quality. A 3-D error diffusion algorithm is proposed in “A 3-D error diffusion dither algorithm for half-tone animation on bitmap screens”, H. Hild and M. Pins, State-of-the-Art in Computer Animation—Proceedings of Computer Animation, Springer-Verlag, pp. 181-190, (1989), which discloses a constant gain control scheme to minimize flickering artifacts. The quantization threshold is adjusted by a single spatially invariant constant for all the pixels. The constant is chosen in an ad hoc way. This has the shortcoming that a particular constant is always too small for some regions and too large for other regions. Therefore there is need for a content-adaptive gain control scheme, which adapts to the static regions, slowly moving regions, and fast moving areas.

In “Halftoning of image sequence” C. Gotsman, The Visual COMPUTER, 9(5), pp. 255-266, (1993), an iterative halftoning algorithm is applied to image sequences. The halftone map on the previous frame is used as the starting point for iterative refinement on the current image frame, thus minimizing the temporal flicker. This approach tends to generate almost identical halftone frames at the expense of spatial quality.

In “Model-based color image sequence quantization” by C. B. Atkins, et al, Proceedings of SPIE/IS&T Conference on Human Vision, Visual Processing, and Digital Display V, vol. 2179, 1994, spatiotemporal error diffusion filters are designed for the luminance and chrominance channels at different temporal sampling rates. The same set of filters is used for all the pixels. This approach tends to exhibit temporal flickers. Examples of halftone frames and flickering artifacts by using 2-D image halftoning techniques are shown in FIGS. 14A-14D.

FIGS. 14A-14B present the halftone frame and the frame difference (flickering artifacts), respectively, by the Floyd-Steinberg 2-D error diffusion image halftoning method. The halftone frame and the frame difference by the 2-D ordered-dither image halftoning method are shown in FIG. 14C and FIG. 14D. The Floyd-Steinberg method gives good spatial rendering in FIG. 14A; however, the flickering artifacts dominate the frame difference in FIG. 14B, in static background as well as the moving foreground. Even in static regions, the method generates alternating black and white dots, yielding poor temporal quality. The ordered-dither image halftoning method enforces temporal consistence aggressively, so the frame difference in FIG. 14D is very small, which means the temporally adjacent halftone frames are almost identical. This leads to poor spatial quality, as shown in FIG. 14C.

The following patent publications bear relevance to this area, which is apparent from their titles: U.S. Pat. No. 4,920,501, “Digital halftoning with minimum visual modulation patterns” to J. R. Sullivan and R. L. Miller; U.S. Pat. No. 4,955,065, “System for producing dithered images from continuous-tone image data” to A. Ulichney; U.S. Pat. No. 5,111,310, “Method and apparatus for halftone rendering of a gray scale image using a blue noise mask” to K. J. Parker and T. Mitsa; and U.S. Pat. No. 5,742,405, “Method and system for forming multi-level halftone images from an input digital image” to K. E. Spaulding and R. L. Miller. International Patent Publication WO 02/45062, “Method and apparatus for controlling a display device” to C. Correa, et. al., discloses a method to reduce flicker effect in display devices that suggests use of a limited number of video levels to alleviate false contour effects.

Psychophysical experiments have been carried out to model the temporal and spatial characteristics of the human visual system. In particular, the temporal characteristics has been studied in “Estimating multiple temporal mechanisms in human vision”, R. E. Fredericksen and R. F. Hess, Vision Research, 38, 1023-1040, (1998), and the spatial counterpart has been studied in “The effects of a visual fidelity criterion on the encoding of images” by J. L. Mannos and D. J. Sakrison, IEEE Trans. Information Theory, 20, 525-536, 1974. It would be desirable to take advantage of the temporal characteristics of human visual system (HVS) in video tone reduction.

It would thus be desirable to provide video tone reduction methods and systems, which take advantage of the temporal characteristics of the human visual system to reduce visual degradation and temporal flicker.

### SUMMARY OF THE INVENTION

The invention is defined by the claims. The invention, in broader aspects, provides a method, apparatus, and system, in which a tone scale of a video is reduced. A cumulative diffused error is added to an initial tone value of a base pixel of a current frame of the video to provide an adjusted tone value of the pixel. A threshold is assigned to said base pixel. The adjusted tone value is quantized using the threshold and a quantization error is generated. First portions of the quantization error are diffused to pixels of temporally neighboring frames and second portions are diffused to spatially neighboring pixels of the current frame. The portions at a next pixel are totalled to provide a respective cumulative diffused error and the assigning, quantizing, and diffusing steps are iterated until all of the pixels of the video frames are processed.

It is an advantageous effect of the invention that improved video tone reduction methods and systems are provided, which take advantage of the temporal characteristics of the human visual system to reduce visual degradation and temporal flicker.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 generally illustrates features of a system in accordance with the present invention.

FIG. 2 shows a block diagram of video rendering and display.

FIG. 3 shows the block diagram of video halftoning based on separable spatial and temporal error diffusion with motion adaptive gain control.

FIG. 4 presents the flow chart of the video halftoning algorithms.

FIG. 5 illustrates 3-D spatiotemporal error diffusion.

FIG. 6 shows the error diffusion of ε⁺(p) to its spatial neighbors and the temporal neighbor on the next frame.

FIG. 7 shows the collection of error ε⁻(p) from its spatial neighbors and the temporal neighbor on the previous frame.

FIGS. 8A, 8B, 8C and 8D present various configurations of the spatial and temporal error diffusion domains.

FIGS. 9A and 9B illustrate (a) the temporal impulse responses, and (b) the temporal frequency responses of the human visual system.

FIGS. 10A and 10B illustrate (a) a 5-tap lowpass temporal filter, and (b) a 5-tap bandpass temporal filter at video frame rate of 30 Hz.

FIGS. 11A and 11B illustrate (a) a 9-tap lowpass temporal filter, and (b) a 9-tap bandpass temporal filter at video frame rate of 60 Hz.

FIG. 12 illustrates the spatial frequency response of the human visual system.

FIGS. 13A and 13B illustrate (a) a single frame of video sequence “Trevor” overlaid with motion vectors to the previous frame, and (b) the same frame of the halftone video at frame rate of 30 Hz.

FIGS. 14A-14D present the halftone frames and the visual differences with the previous frames (flickering artifacts), (a) the halftone frame and (b) the frame difference by the Floyd-Steinberg 2-D error diffusion image halftoning method, (c) the halftone frame and (d) the frame difference by the 2-D ordered-dither image halftoning method.

FIGS. 15A and 15B illustrate (a) the halftone frame and (b) the frame difference by the disclosed video halftoning method.

FIGS. 16A and 16B illustrate (a) the gain control map and (b) the temporal diffusion map at 30 Hz.

### DETAILED DESCRIPTION OF THE INVENTION

In the method of the invention, a continuous tone grayscale or color video is transformed to a halftone or multitone monochromatic or color video with limited intensity resolution. The halftone video product can be used in place of a continuous tone video to accommodate limited capabilities of available equipment or to reduce burden and enhance available capacity or capability. Tone reduced video and halftone video provide an alternative for video representation, rendering, storage, and transmission, when continuous tone video is not necessary or not practical.

The reduced tone video can be used to provide relatively high frame rate video on display devices with limited intensity resolutions and color palettes (due to the constraints of cost and system complexity), such as small electronic gadgets (for example, cellular phone, personal digital assistant (PDA), and vehicle dashboard), large screen display (for example, cinema poster, commercial billboard, and stadium screen), and flexible display (for example, packaging labels).

The reduced tone video provides a technical solution for video storage and transmission at a low bit rate. This is especially applicable at bit rates, in which some video coding technology (such as MPEG) starts to introduce dramatic image distortion and require dropping of frames. The entropy of a halftone or colortone video is much smaller than its counterpart with continuous tone, and it can be further reduced after exploring the temporal consistence of static and slow-moving patterns.

The reduced tone video can provide error resilient communications. Stochastic noise patterns, which are used to conceal the quantization errors in the spatiotemporal domain, are less visible to human eyes than random perturbation on the halftone video, such as channel noise. The result is less pronounced image quality degradation. This makes the reduced tone video particularly suitable for wireless communications.

For convenience, the following discussion generally refers to halftoning/colortoning and a halftone/colortone product that is either black-and-white or single intensity three channel color, as indicated. The term “dithering” and like terms, are used herein to refer to this halftoning/colortoning. It will be understood that the same considerations apply to multitone video embodiments. The following discussion also generally refers to reducing the tone scale of a continuous tone scale initial video. The invention is inclusive of other reductions, for example, from a multitone video to a halftone video. The method is generally described herein in relation to entire frames of sequences of the video or to pixels of a frame that are spaced from edges of the frame. It will be understood that the method can be applied in the same or different manners to different blocks or regions of frames of a sequence. Parallel processing can be used for the different blocks or regions. It will also be understood that the methods can be modified to accommodate edge treatments well known to those of skill in the art.

The method differs from still image halftoning, in that the quantization error at a pixel is spread to its three dimensional (3-D) spatiotemporal neighbors, rather than only the two dimensional spatial neighbors. The 3-D error diffusion takes advantage of the temporal characteristics of human visual system, which tend to conceal the portions of the quantization error spread in the temporal direction. The temporal and spatial portions of the error diffusion can be separable. This can reduce system complexity and computational cost. The temporal error diffusion can be provided along motion trajectories (motion vectors), dependent upon image content in accordance with a temporal diffusion map. The extent of temporal diffusion can be based on the characteristics of human visual system and video frame rates so as to minimize flicker and degradation.

The term “neighbor” and like terms, used herein in relation to pixels, refers to a first set of pixels (also referred to herein as “first order neighbors”) that directly touch a base or current pixel and to a second set of pixels (also referred to herein as “second order neighbors”) that directly touch one of the first order neighbor pixels. In an embodiment having two spatial dimensions, the first order neighbors touch at edges or corners. In an embodiment having three spatial dimensions, the first order neighbors touch at edges or corners or sides. Like considerations apply to image data treated as having more than three spatial dimensions. As a matter of convenience in embodiments discussed in detail herein, neighboring pixels are limited to first order neighbors.

In the method, the quantizing of tone value at pixels is based upon a threshold that can be varied in accordance with a gain control map. The map can be determined by motion fields of the current frame and one or more temporally neighboring frames. The motion-assisted adaptive gain control provided by the map enhances the temporal consistence of visual patterns, thus minimizing the flickering artifacts.

A first order temporally neighboring frame borders a current frame in time sequence. A second order temporally neighboring frame is next in sequence. A practical limit on the number of orders of temporally bordering frames is a function of the frame rate and the human visual response. Temporally neighboring frames are generally discussed herein in relation to frames that succeed a current frame. Preceeding temporally neighboring frames can be utilized, instead of or in addion to succeeding frames, but this necessitates a recursive process, which may not be suitable for real-time uses.

In the following description, a preferred embodiment of the present invention will be described in terms that would ordinarily be implemented as a software program. Those skilled in the art will readily recognize that the equivalent of such software may also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, may be selected from such systems, algorithms, components and elements known in the art. Given the system as described according to the invention in the following materials, software not specifically shown, suggested or described herein that is useful for implementation of the invention is conventional and within the ordinary skill in such arts.

As used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such a personal computer. Consequently, the computer system will not be discussed in detail herein. It is also instructive to note that the images are either directly input into the computer system (for example by a digital camera) or digitized before input into the computer system (for example by scanning an original, such as a silver halide film).

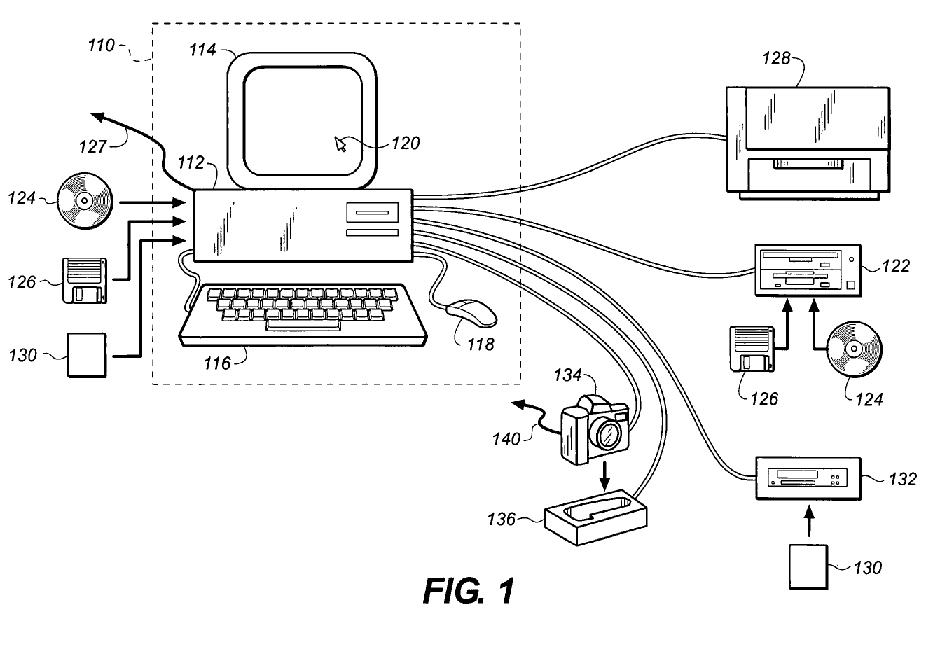

Referring to FIG. 1, there is illustrated a computer system 110 for implementing the present invention. Although the computer system 110 is shown for the purpose of illustrating a preferred embodiment, the present invention is not limited to the computer system 110 shown, but may be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, for example, by means of a graphical user interface. A keyboard 116 is also connected to the microprocessor based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a means of inputting the software programs and other information to the microprocessor based unit 112. In addition, a floppy disk 126 may also include a software program, and is inserted into the microprocessor-based unit 112 for inputting the software program. The compact disk-read only memory (CD-ROM) 124 or the floppy disk 126 may alternatively be inserted into externally located disk drive unit 122 which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images and videos may also be displayed on the display 114 via a personal computer card (PC card) 130, such as, as it was formerly known, a PCMCIA card (based on the specifications of the Personal Computer Memory Card International Association) which contains digitized images electronically embodied in the card 130. The PC card 130 is ultimately inserted into the microprocessor based unit 112 for permitting visual display of the image on the display 114. Alternatively, the PC card 130 can be inserted into an externally located PC card reader 32 connected to the microprocessor-based unit 112. Images may also be input via the compact disk 124, the floppy disk 126, or the network connection 127. Any images and videos stored in the PC card 130, the floppy disk 126 or the compact disk 124, or input through the network connection 127, may have been obtained from a variety of sources, such as a digital camera (not shown) or a scanner (not shown). Images or video sequences may also be input directly from a digital image or video capture device 134 via a camera or camcorder docking port 136 connected to the microprocessor-based unit 112 or directly from the digital camera 134 via a cable connection 138 to the microprocessor-based unit 112 or via a wireless connection 140 to the microprocessor-based unit 112.

Referring now to a detailed embodiment, a digital video sequence
V={I(i,j,k), i=1 . . . M, j=1 . . . N, k=1 . . . K}
is a temporally varying 2-D spatial signal I on frame k, sampled and quantized at spatial location (i,j). Signal I contains a single luminance channel for grayscale video, and two additional chrominance channels for color video. Each channel is quantized to b bits, for example, 8-bit grayscale video and 24-bit color video when b=8. The task of video halftoning is to transform a continuous tone video V (for example b=8) to a dithered video V_{d} with a lower bit depth b_{d}<b (for example b_{d}=1), such that the perceived visual difference is as small as possible.

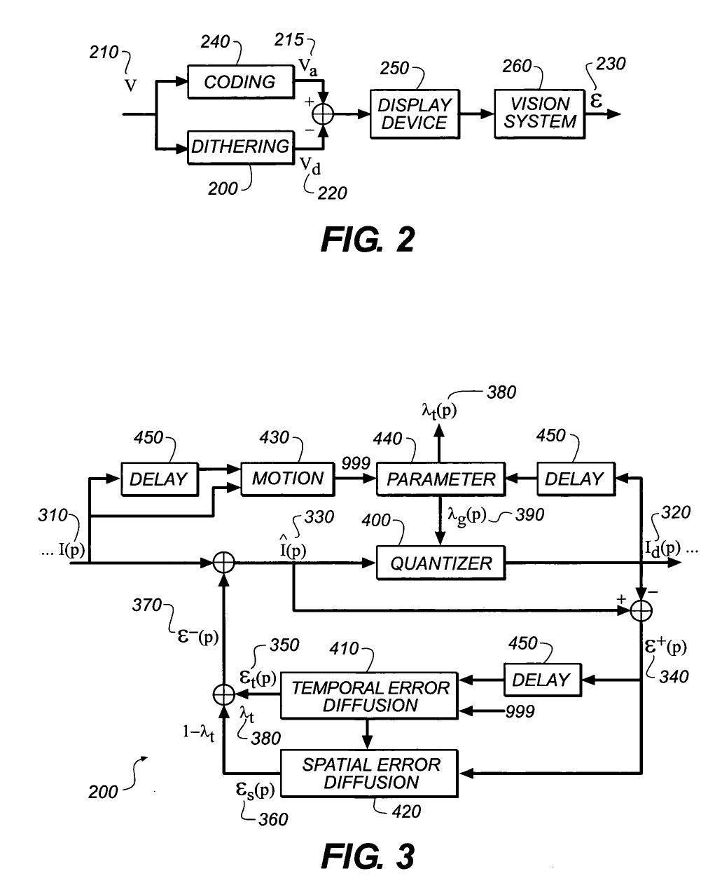

Referring to FIG. 2, video halftoning is formulated as an optimization problem. The same figure can also used for performance evaluation. A digital continuous tone video V 210 is compressed in coding module 240 as Vₐ 215 to remove the spatial, temporal and symbol redundancy. The compression can be either lossless or lossy coding.

The digital continuous tone video can also be dithered in module 200 as a halftone video V_{d} 220. Video halftoning is always a lossy transform. The video is stored, transmitted, displayed, and perceived by human eyes. Display device 250 and vision system 260 can be characterized by the modulation transfer functions (MTF) of H_{d} and Hₑ. For simplicity, we only consider lossless coding and identity display MTF here, that is, Vₐ=V and H_{d}=1, as coding is process dependent and display MTF is device dependent. (With lossy coding, the effect on resolution of the cumulative losses is an additional consideration. Acceptable coding for a particular purpose can be determined heuristically.) The visual difference ε 230 perceived by HVS can be represented as
ε=hₑ\mathring{×}(V−V_{d}),
where \mathring{×} denotes convolution and hₑ is the impulse response of the human vision system. Given a digital video V and the bit depth b_{d} of V_{d}, video halftoning can be formulated as an optimization problem,

$${V}_{d}^{*} = {arg min}_{Vd} {\vert {h}_{e} ⊗ ( V - {V}_{d} ) \vert}^{2}$$

which seeks for the halftone video V_{d} yielding the minimal perceptual error. If hₑ is separable in temporal and spatial dimensions, hₑ=hₛ\mathring{×}hₜ with hₜ and hₛ as the temporal and spatial impulse responses, the visual difference can be further written as

$$\begin{matrix}ɛ = {h}_{s} ⊗ {h}_{t} ⊗ ( V - {V}_{d} ) \\ = {\sum }_{{i}^{′} {j}^{′}} {h}_{s} ( i - {i}^{′} , j - {j}^{′} ) {\sum }_{{k}^{′}} {h}_{t} ( k - {k}^{′} ) ( I ( {i}^{′} , {j}^{′} , {k}^{′} ) - {I}_{d} ( {i}^{′} , {j}^{′} , {k}^{′} ) .\end{matrix}$$

The equation simply expands the 3-D spatiotemporal filter to separable temporal and spatial filters and writes the convolution of video as the convolution of pixel intensities with the filters. Like considerations apply to use of inseparable filters.

Referring to FIG. 3 for details of the disclosed video halftoning scheme, the intensity values of I are normalized to [0,1], with Iₘᵢₙ=0 as black, Iₘₐₓ=1 as white, and Iₘ=0.5 as the middle point. The video frames are processed sequentially, and the pixels inside a frame are scanned in a serpentine order, from left to right on even lines and from right to left on odd lines. This scanning order is currently preferred, but other scanning orders in the spatiotemporal domain can also be used.

At a pixel location p=(i,j,k), the image intensity or tone value I(i,j,k) 310 and the quantization errors diffused from its spatiotemporal neighbors ε⁻(i,j,k) 370 are quantized to I_{d}(i,j,k) 320, by a comparison of the adjusted intensity value Î(i,j,k) 330 with the threshold T(i,j,k). For example, if T(i,j,k)=0.5,

$${I}_{d} ( i , j , k ) = \{ \begin{matrix}0 & if I ( i , j , k ) + {ɛ}^{-} ( i , j , k ) < T ( i , j , k ) \\ 1 & if I ( i , j , k ) + {ɛ}^{-} ( i , j , k ) \geq T ( i , j , k )\end{matrix} .$$

The adjusted intensity value is a summation of the initial tone value and the cumulative diffused error, as expressed by the formula:
\hat{I}(i,j,k)=I(i,j,k)+ε⁻(i,j,k)
Part of the quantization error 340, which is expressed by the formula:
ε⁺(i,j,k)=\hat{I}(i,j,k)−I_{d}(i,j,k),
is diffused along the motion trajectory to the next frame as εₜ 350, and the rest of error is diffused to the intraframe neighbors as εₛ 360 in the spatial domain.

The diffused errors are aggregated together as ε⁻(i,j,k) 370 for the following computation,

$$\begin{matrix}{ɛ}^{-} ( i , j , k ) = {λ}_{t} ( i , j , k ) * {ɛ}_{t} ( i + {d}_{x} ( i , j ) , j + {d}_{y} ( i , j ) , k - 1 ) + \\ ( 1 - {λ}_{t} ( i , j , k ) ) * {\sum }_{{s}^{i} ∈ S} {α}_{i} ( I ( i , j , k ) * {ɛ}_{s} ( i + {s}_{x}^{i} , j + {s}_{y}^{i} , k ) .\end{matrix}$$

The temporal diffusion map λₜ(i,j) 380 on frame k (also denoted as λₜ(i,j,k)) controls the error diffusion weights in temporal direction, and the gain control map λ_{g}(i,j) 390 on frame k (also denoted as λ_{g}(i,j,k)) adaptively changes the threshold used in the quantizer 400. Both maps are estimated in the parameter estimation module 380. Motion vector (dₓ(i,j), d_{y}(i,j)) 999 denotes the horizontal and vertical displacements at location (i,j) in frame k to its correspondence in frame k−1, and can be estimated by the motion estimation module 430. Bilinear interpolation is carried out at the non-integer locations on the temporal error image εₜ. Coefficients αᵢ and the domain S define the error diffusion weights and the spatial neighbors. The delay module 450 is equivalent to Z⁻¹, that is, delaying an image frame Iₖ to Iₖ₋₁.

The fields of motion vectors (dₓ(i,j), d_{y}(i,j)) between video frames can be computed by motion estimation methods, such as the gradient-based, region-based, energy-based, and transform-based approaches. Motion vectors can also be provided as metadata associated with respective frames of the input video, such as the compressed MPEG, QUICKTIME, or streaming video with block motion vectors. In such compressed video streams, motion vectors are coded together with the I-frames (intra frame) to predict the P-frames (predictive frames) and B-frames (bi-directional predictive frames). The motion vectors can be decoded directly from video streams without further computation.

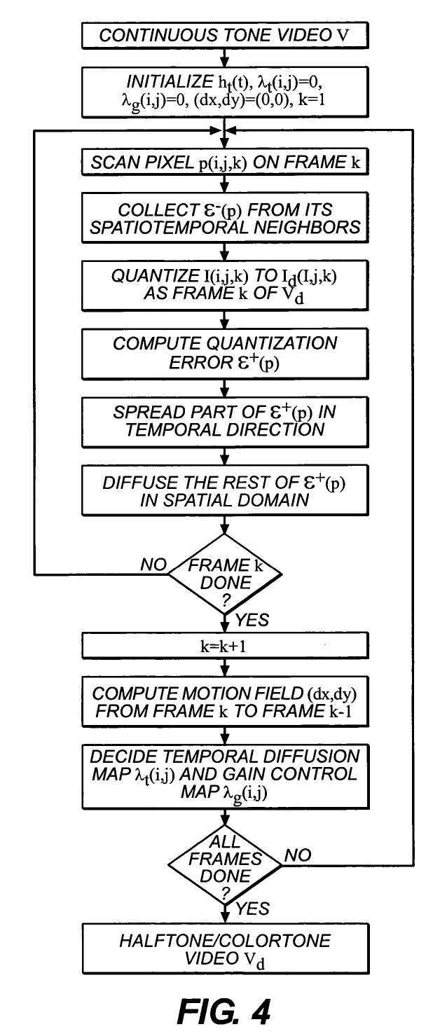

FIG. 4 is a flow chart of one embodiment of the video halftoning algorithm. The input is a grayscale or color video sequence V with continuous tone. The output is a halftone/colortone video V_{d} with lower bit depth. The details of the operations are listed in the following.

1) Initialize temporal finite impulse response (FIR) filter ht, temporal diffusion map λₜ(i,j)=0, gain control map λ_{g}(i,j)=0, motion field (dₓ,d_{y})=(0,0), and frame index k=1.

2) Scan pixel p=(i,j,k) in a serpentine order on frame k.

3) Collect the cumulative diffused error ε⁻(i,j,k) from the spatiotemporal neighbors.

4) Quantize I(i,j,k) to I_{d}(i,j,k) as frame k of V_{d}.

5) Compute quantization error ε⁺(i,j,k).

6) Spread part of ε⁺(i,j,k) in temporal direction if k<or =K.

7) Diffuse the rest of ε⁺(i,j,k) in spatial domain.

8) Go to step 2) for the rest of the pixels, then set k=k+1.

9) Compute motion field (dₓ,d_{y}) from frame k to frame k−1.

10) Generate temporal diffusion map λₜ (i,j).

11) Generate gain control map λ_{g}(i,j).

12) Go back to step 3) until k>K.

The method can be simplified, in particular uses in which motion is predictable, such as some machine vision uses. In those cases, a fixed temporal diffusion map and gain control map can be used and steps 9-11 above can be deleted.

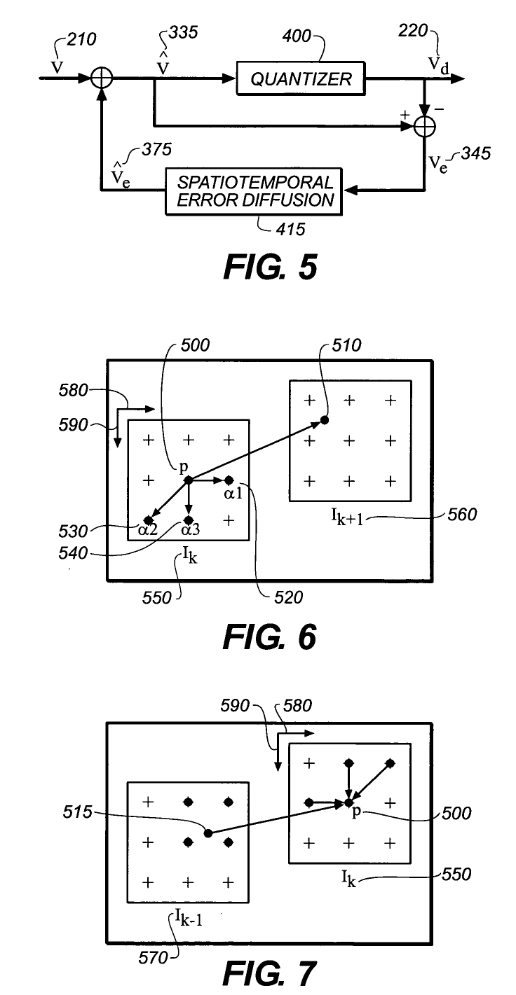

The disclosed separable temporal and spatial error diffusion scheme with adaptive gain control can be simplified as a 3-D spatiotemporal error diffusion, as shown in FIG. 5. An incoming video V 210 along with the previously diffused error \hat{V}ₑ 375, that is,
\hat{V}=V+\hat{V}ₑ,
are quantized in module 400 as the halftone video V_{d} 220. The quantization error 345
Vₑ=\hat{V}−V_{d}
is spatiotemporally filtered in 415 and fed back to the input. Compared to the operations on pixels and regions of pixels, operations on video entities (for example, group of frames (GOP)) introduce delay and require higher system complexity to handle a lot of data simultaneously. Any compromise will introduce additional artifacts, such as temporal flicker.

A particular configuration of the spatiotemporal domain for separable temporal and spatial error diffusion is shown in FIG. 6 and FIG. 7. Inside current frame Iₖ 550, pixels are scanned in horizontal direction 570 and vertical direction 580 in a serpentine order. The quantization error ε⁺ (i,j,k) at the current pixel location p=(i,j,k) 500 is diffused to its temporal correspondence location 510 in frame Iₖ₊₁ 560 along motion trajectory (that is, the respective motion vector), and its causal spatial neighbors 520, 530 and 540. The coefficients αᵢ control the weights for spatial error diffusion. In FIG. 7, the carry term of ε⁻ (i,j,k) is collected from its spatial neighbors and its correspondence location 515 in the previous frame Iₖ₋₁. Bilinear interpolation is necessary for the non-integer locations. This particular approach is simple and efficient.

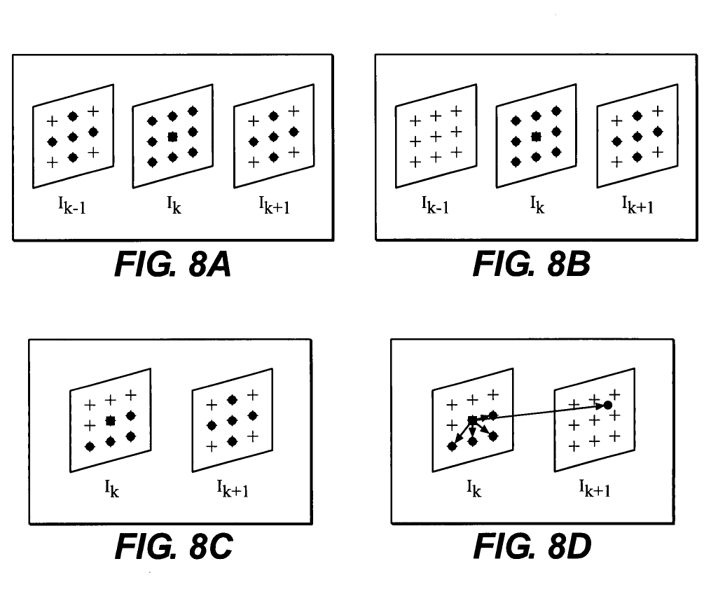

Other configurations involving different spatial and temporal supports are also possible. Four examples are shown in FIGS. 8A-8D, where · indicates the spatiotemporal neighbors involved in the computation of the intensity/color value at the current pixel. In FIG. 8A, the configuration involves 8 spatial neighbors and 10 temporal neighbors (5 on the previous frame and 5 on the next frame). In FIG. 8B, temporal causality is enforced (that is, no pixels in the previous frames are used) and the configuration is simplified, with 8 spatial neighbors and 5 temporal neighbors in the next frame. In FIG. 8C, spatial causality is also enforced and the configuration has 4 spatial neighbors and 4 temporal neighbors. If the motion vectors between video frames are available, the temporal neighbors can be further simplified as the one on motion trajectory as shown in FIG. 8D, which may not located on integer lattice.

The details of the temporal and spatial error diffusions used in FIG. 3 and FIG. 4 will be presented in the following. Temporal error diffusion propagates part of the quantization error ε⁺(i,j,k) 340 to the next frame along motion trajectory. The temporal diffusion map λₜ(i,j) 380 is content-dependent, and can be decided by the temporal characteristics of human visual system and the video frame rate.

The temporal response of HVS is complicated and less well known than its spatial counterpart. A model has been proposed based on the psychophysical experiments, consisting of a lowpass filter and a bandpass filter. It uses function

$$h ( t ) = exp \{ - {( \frac{ln ( t / τ )}{σ} )}^{2} \}$$

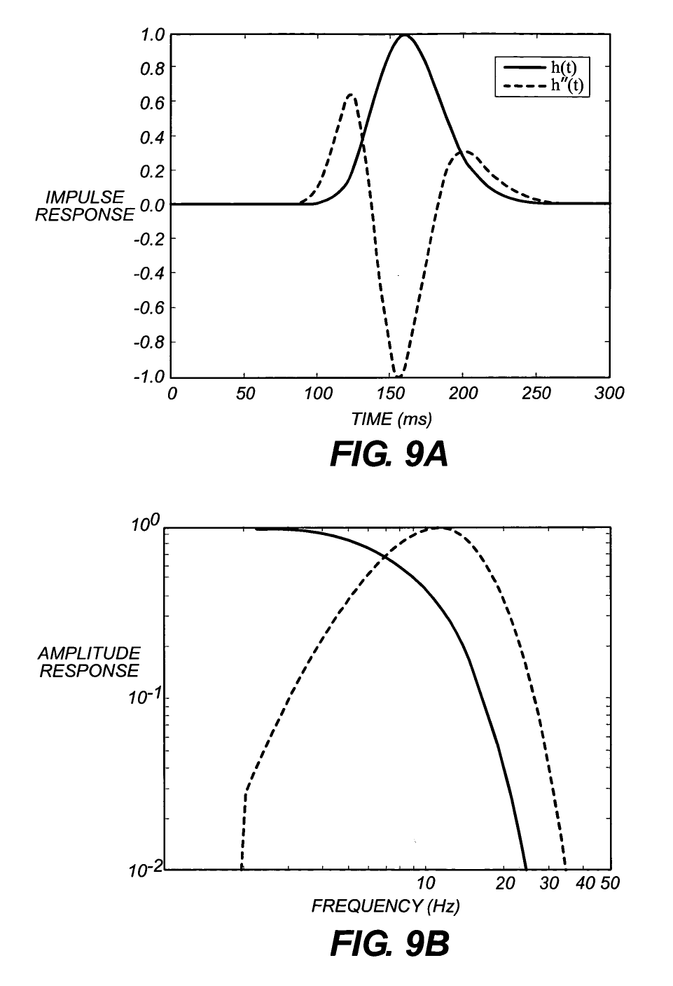

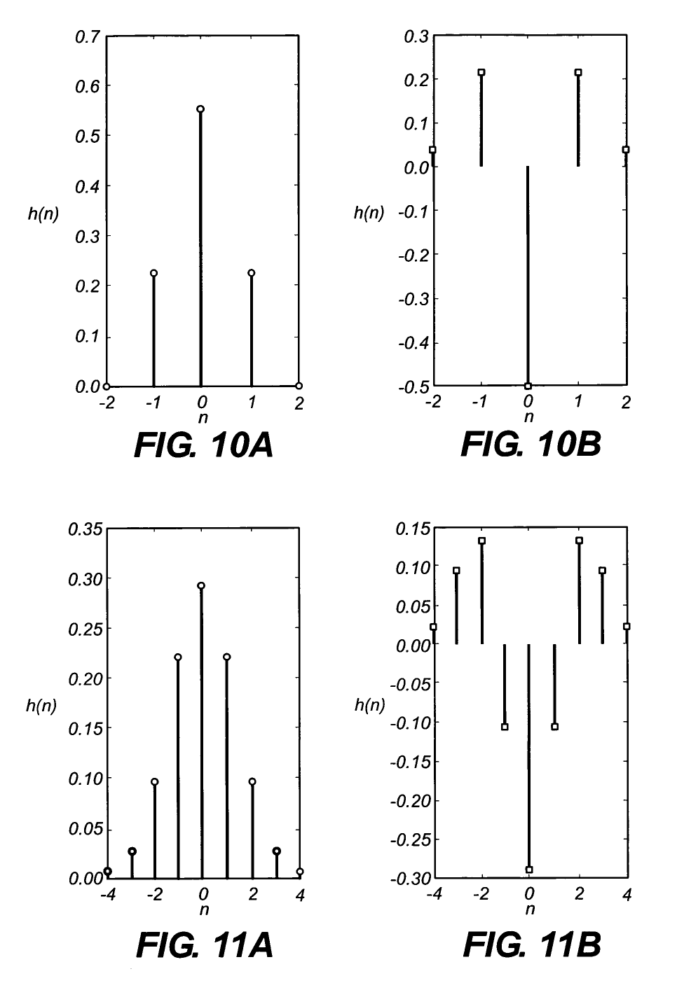

and its high order derivatives to model the temporal mechanism of the targets on the center of human eyes. The filter coefficients at time t vary with the choices of model h(t), scale parameter σ, and time-to-peak parameter τ. Function h(t) and its normalized second order derivative h″(t), with σ=160 ms and τ=0.2 second, are shown in FIG. 9A as solid and dotted lines, respectively. The frequency responses are depicted in FIG. 9B, showing one lowpass filter (solid line) and one bandpass filter (dotted line). Finite impulse response filters with linear phase can be designed at various video frame rates. For example, at the frame rates of 30 Hz and 60 Hz, a total of 5 and 9 video frames fall into the time span of h(t) and h″(t). A 5-tap lowpass FIR filter and a 5-tap bandpass filter for 30 Hz video are shown in FIG. 10, and the 9-tap lowpass and bandpass FIR filters for 60 Hz video are shown in FIG. 11.

Based on the temporal filter, the temporal diffusion map λₜ(i,j) on frame k (a.k.a, λₜ(i,j,k)) can be decided such that the major part of the noise energy falls into the stopband of Hₜ. A possible choice is

$${λ}_{t} ( i , j , k ) = 1 - exp \{ - \frac{{( I ( i , j , k + {k}^{′} ) - \vec{I} ( i , j , k + {k}^{′} ) )}^{2}}{2 {σ}_{t}^{2}} \} ,$$

where \overline{I}(i,j,k)=hₜ(k)\mathring{×}I(i,j,k) is the temporally smoothed version of I(i,j,k), which can be done by temporal lowpass filtering. At low frame rates (<10 Hz), λₜ becomes 0 as \overline{I}(i,j,k)=I(i,j,k), there will be no temporal error diffusion. This also happens in the static regions at high frame rates. In the fast moving regions at high frame rates, λₜ approaches to 1, allowing more quantization error to diffuse across frames. The high frequency noises become less visible after temporal smoothing by HVS. At frame rates higher than 60 Hz, the temporal masking effect of human eyes can be taken into consideration. In the HVS, the sensation of high contrast pattern lasts a finite duration, and some frames can be dropped.

Turning now to the spatial error diffusion for the rest of the quantization error ε⁺(i,j,k), image halftoning techniques can be carried out with adaptive gain control. For 2-D error diffusion, this involves the choice of causal neighbors and the design of the error diffusion filter.

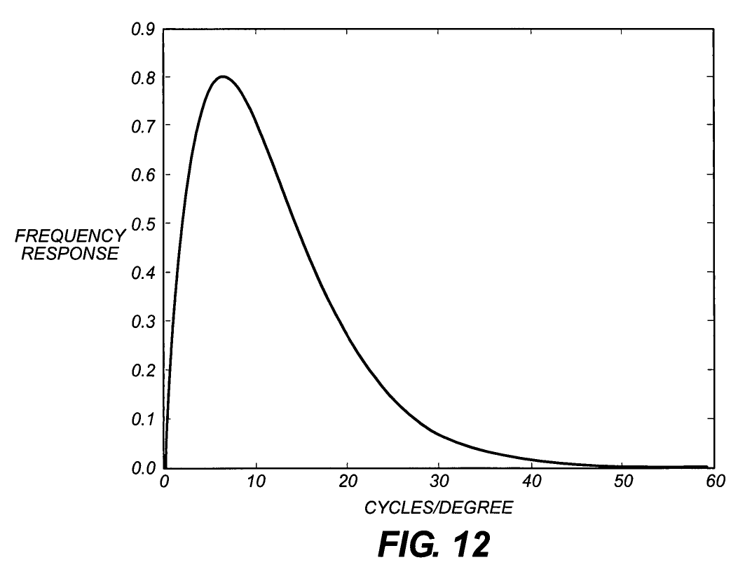

Based on the psychophysical experiments, a proposed model of the spatial frequency response of HVS is:
Hₛ(fₛ)=2.6(0.0192+0.114fₛ)exp{−(0.114fₛ)^{1.1}},
where fₛ is the frequency in degrees per cycle. As shown in FIG. 12, the model has a low pass characteristics, with a peak at 8 cycles/degree and dropping to 0 beyond 30 cycles/degree. Thus, it is desirable to distribute the quantization error in the high frequency bands as the “blue noise”, so it is less visible to human eyes. Numerous image halftoning algorithms, including those referenced before, can be used for this purpose.

In the following, a motion-assisted adaptive gain control scheme is disclosed to alleviate the temporal flickering artifacts, that is, the frequent change of black and white patterns at the same spatial location over time. The solution of increasing the temporal consistence is to adaptively adjust the threshold used in quantization decision in the quantizer module 400. To this end, the threshold is revised as:
T(i,j,k)=(1−sign{I_{d}(i,j,k−1)−Iₘ}*λ_{g}(i,j,k))*Iₘ,
where sign { } is a function returning the sign of the argument, 1 if it is positive, −1 if it is negative, and 0 if it is 0. This increases the inertia of interframe halftoning, making I_{d}(i,j,k) similar to I_{d}(i,j,k−1) unless the spatiotemporally diffused error is large enough.

The quantization threshold is adaptively adjusted to increase the temporal inertia of video halftoning in static and slowly moving regions at low video frame rate, and to encourage free error diffusion in fast moving regions at high frame rate to conceal the quantization errors.

The content-dependent gain control map λ_{g}(i,j) on frame k (also denoted as λ_{g}(i,j,k)), which is used in the threshold T(i,j,k), can be chosen as

$${λ}_{g} ( i , j , k ) = exp ( - \frac{{d}_{x}^{2} ( i , j ) + {d}_{y}^{2} ( i , j )}{2 {σ}_{g}^{2}} )$$

where (dₓ,d_{y}) is the motion vector from point (i,j) in frame k to its correspondence in frame k−1. In static and slow-moving regions, λ_{g}(i,j,k) is close to 1 and the halftoning of I(i,j,k) is strongly biased to I_{d}(i,j,k−1) for enhanced temporal consistence. In fast moving regions with large motion vectors, λ_{g}(i,j,k) is close to 0, and free error diffusion is encouraged to conceal the quantization error. σ_{g} is a scale factor (for example, 0.75) guiding the transition from slow to fast motion. Numerous motion estimation algorithms can be used to compute (dₓ,d_{y}), such as gradient-based, region-based, energy-based, and transform-based approaches. In the regions with outliers, due to occasional model violation or occlusion, λ_{g} is set to 0. It is also helpful to run a median filtering on λ_{g}(i,j) to smooth out any inconsistent outliers.

An alternative model of λ_{g}(i,j,k) without motion estimation is to use the temporal variance of adjacent frames instead of the motion vectors,

$${λ}_{g} ( i , j , k ) = exp ( - \frac{E \{ {( I ( i , j , k ) - E \{ I ( i , j , k ) \} )}^{2} \}}{2 {σ}_{g}^{′ 2}} )$$

where expectation

$$E \{ I ( i , j , k ) \} = \frac{1}{2 q + 1} {\sum }_{{k}^{′} = - q}^{q} I ( i , j , k + {k}^{′} )$$

is a windowed average of temporal intensity, with scale factor σ_{g}, specifying the intensity deviation (for example 5).

Another alternative is to use the temporal highpass filtering as a measure of the intensity changes

$${λ}_{g} ( i , j , k ) = exp ( - \frac{{( {h}_{h} ( k ) ⊗ I ( i , j , k ) )}^{2}}{2 {σ}_{g}^{″ 2}} ) ,$$

where hₕ(k) is a bandpass/highpass temporal filter.

The video tone reduction can be applied to change a continuous tone color video sequence into a colortone video. A colortone video V_{d} is a halftone rendering (for example, b_{d}=1) of a continuous tone color video (for example b=8) with a limited number of colors. The colortone video frames have two chrominance channels in addition to the luminance channel. The presence of the additional channels adds more flexibility and complexity to diffuse and conceal the quantization errors in color space as well as the spatiotemporal domain, so as to make the quantization errors least visible to HVS. For display applications, the color error diffusion is carried out in RGB color space. For example, the digital video halftoning scheme presented in FIG. 3 and FIG. 4 can be applied directly to colortone video generation if color dependency is ignored, by replacing the scalar intensity variable I(i,j,k) with a vector color variable
I(i,j,k)=(rᵢⱼₖ,gᵢⱼₖ,bᵢⱼₖ).
Separable error diffusion is carried out in each channel independently. It is also desirable to use color dependency and diffuse quantization errors across color channels. For example, human eyes are less sensitive to the noise in chrominance channels than the luminance channel. This requires use of a more sophisticated model of human vision system and more complicated error diffusion filters.

In a particular embodiment for colortone video generation, separable temporal and spatial error diffusion is carried out independently in each color channel. A temporal finite impulse response filter is designed based on temporal vision characteristics and the video frame rate. Motion is estimated from the luminance channels, or extracted from the compressed video stream. A temporal diffusion map and gain control map are designed based on the luminance information and shared by all the color channels. On each color channel, the pixels are scanned in a serpentine order on a frame, ε⁻(i,j,k) is collected from the spatiotemporal neighbors, the color component of I(i,j,k) is quantized to that of I_{d}(i,j,k), the quantization error ε⁺(i,j,k) is computed, portions of ε⁺(i,j,k) are diffused in the temporal direction if k< or =K and the remaining portions of ε⁺(i,j,k) are diffused in the spatial domain. The previous steps are repeated until all the pixels are processed.

In summary, the disclosed video halftoning technique provides alternative ways for video representation, rendering, storage, transmission, and display. It can be used in various display devices, including OLED (Organic Light-Emitting Diode), LCD (Liquid Crystal Display), and CRT (Cathode Ray Tube), suitable for rendering dynamic videos on electronic gadgets, such as cellular phone, personal digital assistant (PDA), game console, and vehicle dashboard. It can also be used for large screen video display, such as cinema poster, commercial billboard, and stadium screen. It can be used for video compression due to the tone scale reduction and enhanced temporal consistence of visual patterns. In addition, the technique can also be used for robust video transmission, such as wireless communications due to its data reduction and error resilient characteristics,

### EXAMPLES

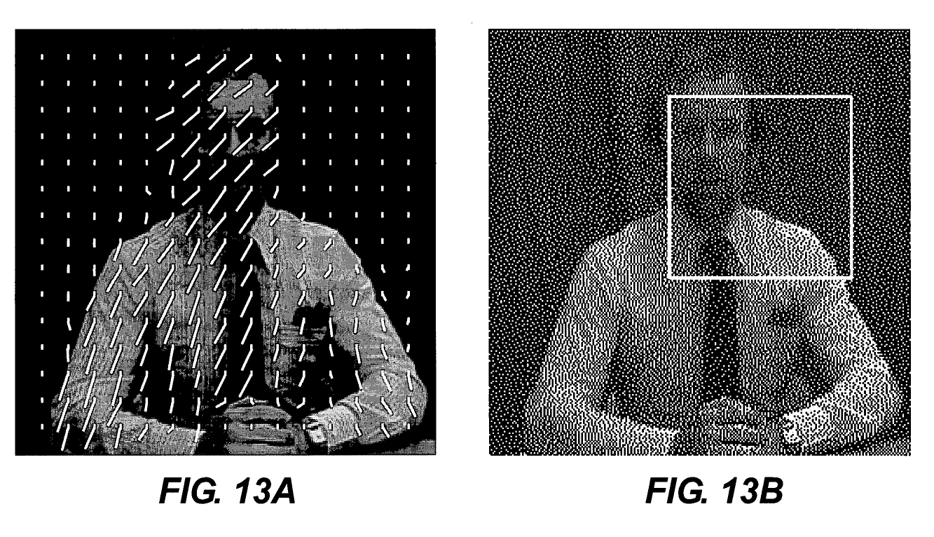

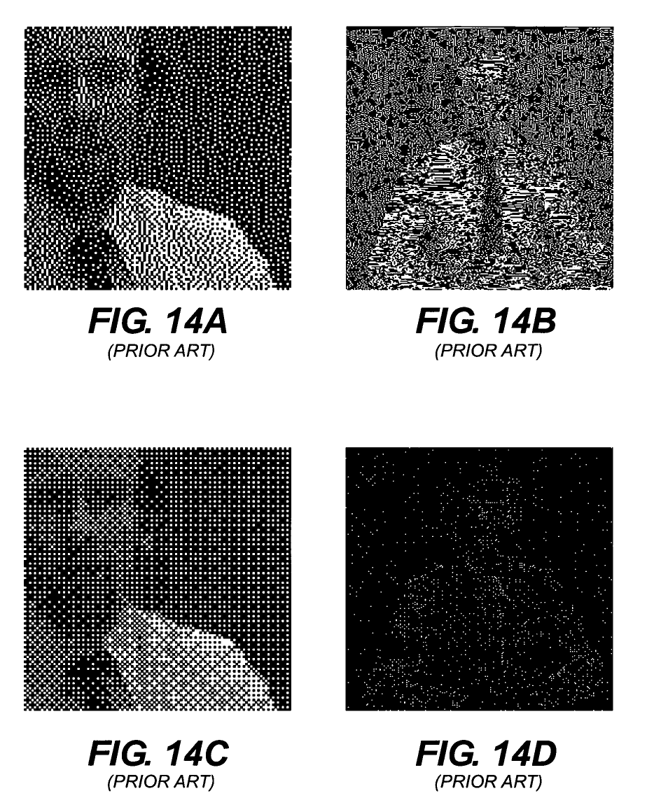

In the following, a particular continuous tone video sequence and corresponding halftone video show features of the method. The grayscale continuous tone video “Trevor” has a spatial resolution of 256×256 and a bit depth of 8 bits per pixel. The video is shot by a static camera, with a static textured background and a moving foreground (a person wearing highly textured shirt and tie). One of the frames is shown in FIG. 13A, overlaid with motion vectors to the previous frame. The motion field shows dominant motion of the person against a static background. The corresponding frame of the halftone video with 1 bit per pixel is presented in FIG. 13B. Black and white dots are used to give a sensation of increased tone scale.

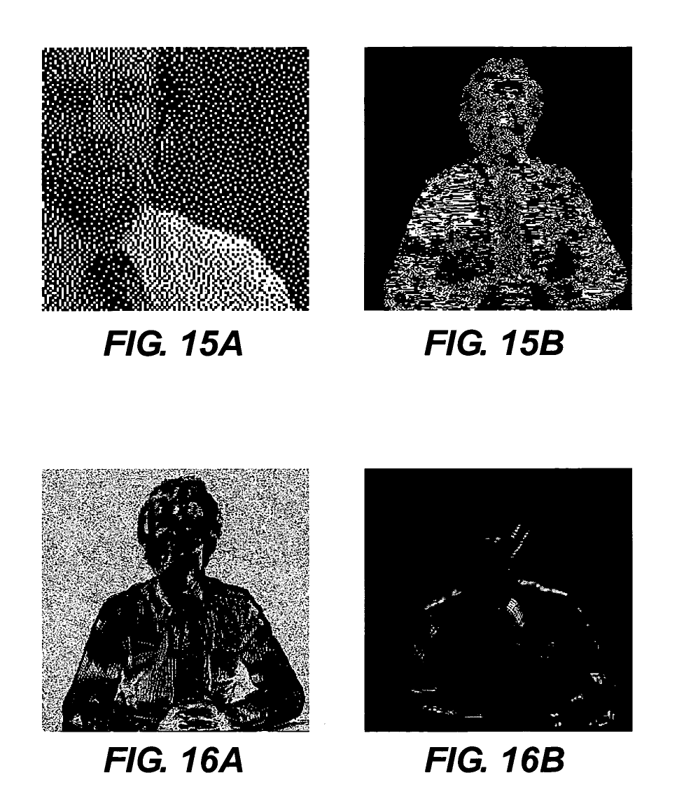

The results of halftone frame and frame difference by the disclosed video halftoning method are shown in FIG. 15A and FIG. 15B. The background regions are clear of flickering artifacts. Error diffusion is encouraged in the moving regions to capture fast motion.

Examples of the gain control map and the temporal diffusion map are shown in FIG. 16A and FIG. 16B. The gain control maps λ_{g}(i,j) adaptively adjust the threshold used in quantization to enhance temporal consistence. The white regions in FIG. 16A denote static and slowly moving patterns, which have high probability of the same halftone patterns as the previous frames. The dark regions denote fast moving patterns which encourage free error diffusion for best possible image reproduction. The temporal diffusion map λₜ(i,j) determines the weights for temporal and spatial error diffusions. It tends to increase at high video frame rates. The dark regions in FIG. 16B diffuse all quantization errors in intraframe, and the white regions spread more errors across frames.

The invention has been described in detail with particular reference to certain preferred embodiments thereof, but it will be understood that variations and modifications can be effected within the spirit and scope of the invention.

1. A method for reducing tone scale of a video, said video having a plurality of frames, each of the frames having a plurality of pixels, the method comprising the steps of:
adding a cumulative diffused error to an initial tone value of a base pixel of a current frame of said video to provide an adjusted tone value of said base pixel;
assigning a threshold to said base pixel;
quantizing said adjusted tone value using said threshold, said quantizing generating a quantization error;
diffusing first portions of said quantization error to one or more pixels of one or more succeeding frames temporally neighboring said current frame and second portions of said quantization error to one or more pixels spatially neighboring said base pixel;
totalling said portions diffused to each said neighboring pixel to provide a respective cumulative diffused error;
iterating said assigning, quantizing, and diffusing steps with one of said neighboring pixels as base pixel until all of the pixels on all of the video frames are processed.

2. The method of claim 1 further comprising adaptively adjusting said threshold during said iterating.

3. The method of claim 2 wherein said adaptively adjusting further comprises:
determining motion fields between said current frame and said temporally neighboring frames;
generating a gain control map and a temporal diffusion map from said motion fields; and
applying said maps during said quantizing and diffusing steps, respectively.

4. The method of claim 3 wherein said generating further comprises applying a finite impulse response filter to said motion fields.

5. The method of claim 2 wherein said adaptively adjusting is a function of the motion between said current frame and said temporally neighboring video frames.

6. The method of claim 3 wherein said generating of said gain control map further comprises convolving said image intensities with a bandpass/highpass temporal filter.

7. The method of claim 1 wherein said diffusing of said first portions is along motion trajectories.

8. The method of claim 7 further comprising bilinearly interpolating at non-integer locations along said motion trajectories.

9. The method of claim 1 wherein said adaptively adjusting is a function of the initial tone values of said base pixel and of temporally neighboring pixels at the same spatial location.

10. The method of claim 1 further comprising the steps of:
determining motion fields between said current frame and said temporally neighboring frames;
generating a gain control map from said motion fields; and
adaptively adjusting said threshold during said iterating according to said gain control map.

11. The method of claim 10 further comprising smoothing said gain control map.

12. The method of claim 10 further comprising generating a temporal diffusion map from said motion fields, said temporal diffusion map defining said neighboring pixels prior to said diffusing.

13. The method of claim 10 wherein said motion fields are determined by motion estimation computations.

14. The method of claim 13 wherein said motion estimation computations are gradient-based, region-based, energy-based, or transform-based.

15. The method of claim 10 wherein said determining motion fields further comprises reading motion vector metadata associated with said frames.

16. The method of claim 1 further comprising the steps of:
determining motion fields between said current frame and said temporally neighboring frames; and
generating a temporal diffusion map from said motion fields, said temporal diffusion map defining said neighboring pixels prior to said diffusing.

17. The method of claim 16 further comprising adaptively adjusting said diffusing during said iterating according to said temporal diffusion map.

18. The method of claim 17 wherein said magnitudes of said first and second portions of said quantization error are adjusted during said iterating proportional to the magnitudes of motion vectors of said motion fields.

19. The method of claim 1 wherein said diffusing of said first portions and said diffusion of said second portions is separable.

20. Apparatus for reducing tone scale of an initial video having a plurality of frames, said video comprising:
a motion estimation module determining motion vectors between temporally adjacent frames;
a parameter estimation module determining a motion-assisted gain control map and a temporal diffusion map, said gain control map defining a plurality of thresholds, said thresholds being adaptive to said motion vectors; and
a quantization module quantizing the initial video according to said thresholds, said quantizing defining quantization error;
a temporal error diffusion module diffusing first portions of the quantization error along said motion vectors responsive to said diffusion map;
a spatial error diffusion module diffusing second portions of the quantization error spatially.

21. The apparatus of claim 20 wherein said motion estimation module determines said motion vectors by motion estimation computations.

22. The apparatus of claim 21 wherein said motion estimation computations are gradient-based, region-based, energy-based, or transform-based.

23. The apparatus of claim 20 wherein said motion estimation module reads motion vector metadata associated with said frames and determines said motion vectors responsive to said reading.

24. The apparatus of claim 20 further comprising a display operatively connected to said modules.

25. The apparatus of claim 24 wherein said display is incapable of displaying said initial video.

26. The apparatus of claim 25 wherein said display is portable.

27. A system comprising the combination of said apparatus and a source supplying said initial video.
